(19) United States
(12) Patent Application Publication
(10) Pub. No.: US 2012/0169988 A1
(43) Pub. Date: Jul. 5, 2012

(54) CAMERA MODULE

(75) Inventor: Young Ho KO, Gyunggi-do (KR)

(73) Assignee: SAMSUNG ELECTRO-MECHANICS CO., LTD., Gyunggi-do (KR)

(21) Appl. No.: 13/340,377

(22) Filed: Dec. 29, 2011

(30) Foreign Application Priority Data
Dec. 29, 2010 (KR) 10-2010-0137808

(51) Int. Cl. G02F 1/13

(52) U.S. Cl. 349/200

(57) ABSTRACT

Disclosed herein is a camera module including: a lens barrel having a lens mounted thereon; a housing having the lens barrel received therein; a printed circuit board connected to a lower portion of the lens barrel and fixed to the housing; and an LC lens module including an LC lens having the center positioned on the same axis as the center of the lens and coupled to the housing. The LC lens is positioned so as to correspond to the center axis of the lens, such that auto-focusing may be efficiently and stably implemented, and electrical connection parts coupling the LC lens to the LC lens module are exposed to the outside of the housing, such that a connection state may be checked with the naked eyes and additional repair may be easily and simply performed.

### CROSS REFERENCE TO RELATED APPLICATION

This application claims the benefit of Korean Patent Application No. 10-2010-0137808, filed on Dec. 29, 2010, entitled “Camera Module”, which is hereby incorporated by reference in its entirety into this application.

### BACKGROUND OF THE INVENTION

1. Technical Field

The present invention relates to a camera module.

2. Description of the Related Art

Recently, as a rate of a smart phone providing various displays and applications in a mobile communication terminal increases, the demand for reduction of a module size for high density mounting in an inner portion of a set and a high specification hardware module has increased.

Therefore, as a camera module for a mobile communication terminal, a high pixel auto-focusing module that has a micro sized and micro thin structure and may photograph a moving picture has been developed.

Particularly, the lens driving type auto-focusing module according to the prior art has a limitation in satisfying requirements such as a high pixel, a multi-function, a micro size, and a micro thin thickness.

Further, in the case of a piezo-actuator, a voice coil actuator, or the like, that is widely used in order to move a lens barrel for auto-focusing automatically adjusting a focus and a hand vibration function, foreign materials are introduced into a printed circuit board, an infrared (IR) filter, or the like, of a camera module due to driving by the actuator, such that a defect, an operation error, and the like, occur. In order to solve the above-mentioned problem, a structure including a foreign material blocking member and a method changing a shape has been prepared. However, this structure and method can not basically solve the above-mentioned problem.

### SUMMARY OF THE INVENTION

The present invention has been made in an effort to provide a camera module including a liquid crystal (LC) lens of which arrangement of a liquid crystal layer is adjusted by application of voltage to be auto-focused, in which the center of the LC lens is positioned so as to correspond to the center axis of a lens, such that a foreign material generation problem due to an actuator may be basically solved and auto-focusing may be stably implemented, and in which electrical connection parts coupling the LC lens to an LC lens module are exposed to the outside of a housing, such that a connection state may be checked with the naked eyes and additional repair may be easily and simply performed.

According to a preferred embodiment of the present invention, there is provided a camera module including: a lens barrel having a lens mounted thereon; a housing having the lens barrel received therein and guide parts formed thereon; a printed circuit board connected to a lower portion of the lens barrel and fixed to the housing; and an LC lens module including an LC lens and guided to the guide parts of the housing to thereby be coupled to the housing so that the LC lens is positioned on the same axis as the center of the lens.

The guide parts may be guide protrusions formed at edges of an upper portion of the housing, and the LC lens module may be locked in the guide protrusions to be coupled to the housing, such that the center of the lens and the center of the LC lens are positioned on the same axis.

The LC lens module may include: the LC lens of which arrangement of a liquid crystal layer is adjusted by application of voltage; an LC lens module body having the LC lens supported thereby and coupled thereto and fixed to the housing; and a contact pin part electrically connected to the printed circuit board.

The guide parts may be guide protrusions formed at edges of an upper portion of the housing, and the LC lens module may include the LC lens of which arrangement of a liquid crystal layer is adjusted by application of voltage, an LC lens module body having the LC lens supported thereby and coupled thereto and provided with fixing grooves corresponding to the guide protrusions of the housing, and a contact pin part formed in the module body so as to be electrically connected to the printed circuit board, wherein the fixing grooves of the LC lens module are inserted into the guide protrusions of the housing to fix the LC lens module to the housing.

The LC lens module may further include conductive bonding parts electrically connecting the LC lens to the LC lens module body.

The LC lens module body may be provided with a flexible connection part having changeable connection direction so that the LC lens is positioned over the housing so as to correspond to the lens and the contact pin part is positioned on a side portion of the housing so as to contact the printed circuit board.

### BRIEF DESCRIPTION OF THE DRAWINGS

FIG. 1 is a schematic perspective view of a camera module according to a preferred embodiment of the present invention; and

FIG. 2 is a schematic exploded perspective view of the camera module shown in FIG. 1.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, a camera module according to preferred embodiments of the present invention will be described with reference to the accompanying drawings.

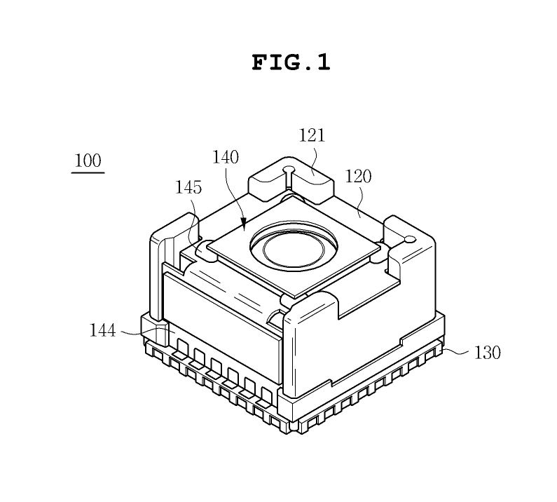

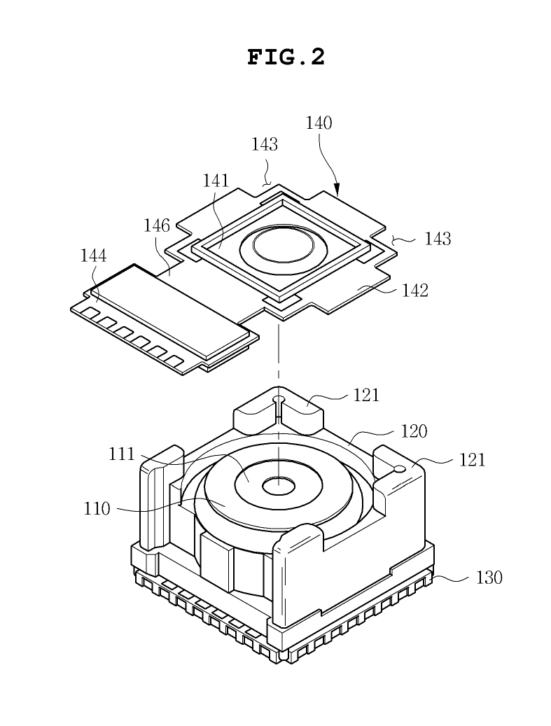

FIG. 1 is a schematic perspective view of a camera module according to a preferred embodiment of the present invention; and FIG. 2 is a schematic exploded perspective view of the camera module shown in FIG. 1. As shown, the camera module 100 is configured to include a lens barrel 110, a housing 120, a printed circuit board 130, an infrared (IR) filter (not shown), and an LC lens module 140.

The lens barrel 100 includes a lens 111 mounted thereon, is received in the housing 120, and includes the printed circuit board 130 connected to a lower portion thereof, wherein the printed circuit board 130 is fixed to the housing. In addition, the IR filter (not shown) is coupled to the printed circuit board 130 and is received in the housing in a state in which it is positioned between the printed circuit board 130 and the lens barrel 110.

The LC lens module 140 includes an LC lens 141 of which the center is positioned on the same axis as the center of the lens 111 and is coupled to the housing 120. In addition, the housing 120 includes guide protrusions 121 formed at edges of an upper portion thereof in order to accurately and stably couple the LC lens module 140 thereto.

More specifically, the LC lens module 140 includes the LC lens 141 of which arrangement of a liquid crystal layer is adjusted by application of voltage to thereby be auto-focused, an LC lens module body 142 having the LC lens 141 supported thereby and coupled thereto and fixed to the housing 120, and a contact pin part 144 electrically connected to the printed circuit board. In addition, the LC lens module 140 is provided with fixing grooves 143 corresponding to the guide protrusions 121 of the housing. The fixing grooves 143 of the LC lens module 140 are inserted into the guide protrusions 121 of the housing 120, such that the LC lens module 140 is fixed to the housing 120.

The guide protrusions 121 of the housing 120 and the fixing grooves 143 of the LC lens module 140 according to the preferred embodiment of the present invention, which are to stably and simply couple the LC lens module 140 to the housing 120 simultaneously with allowing the central axis of the lens 111 and the central axis of the LC lens 141 to coincide with each other, may have various shapes and numbers. FIGS. 1 and 2 show that four guide protrusions are formed at the edges of the upper portion of the housing by way of example.

In addition, the housing 120 according to the preferred embodiment of the present invention is provided with guide grooves instead of the guide protrusions 121, and the LC lens module 140 is provided with fixing protrusions corresponding to the guide grooves, such that the LC lens module 140 may also be fixed to the housing 120 in a scheme in which the fixing protrusions are inserted into the guide grooves.

Further, the LC lens 141 of the LC lens module 140 is electrically connected to the LC lens module body 142 by conductive bonding parts 145. In addition, the conductive bonding parts 145 are exposed to the outside of the housing 120, such that connection and contact states may be checked with the naked eyes and additional repair may be easily and simply performed.

Further, the LC lens module body 140 according to the preferred embodiment of the present invention is provided with a flexible connection part 146 having a changeable connection direction so that the LC lens 141 is positioned over the housing 120 so as to correspond to the lens 111 and the contact pin part 144 is positioned on a side portion of the housing so as to contact the printed circuit board 130.

According to the preferred embodiment of the present invention, it is possible to provide a camera module including a liquid crystal (LC) lens of which arrangement of a liquid crystal layer is adjusted by application of voltage to be auto-focused, in which the center of the LC lens is positioned so as to correspond to the center axis of a lens, such that a foreign material generation problem by an actuator may be basically solved and auto-focusing may be stably implemented, and in which electrical connection parts coupling the LC lens to an LC lens module are exposed to the outside of a housing, such that a connection state may be checked with the naked eyes and additional repair may be easily and simply performed.

Although the embodiment of the present invention has been disclosed for illustrative purposes, it will be appreciated that a camera module according to the invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims

What is claimed is:

1. A camera module comprising:
a lens barrel having a lens mounted thereon;
a housing having the lens barrel received therein and guide parts formed thereon;
a printed circuit board connected to a lower portion of the lens barrel and fixed to the housing; and
an LC lens module including an LC lens and guided to the guide parts of the housing to thereby be coupled to the housing so that the LC lens is positioned on the same axis as the center of the lens.

2. The camera module as set forth in claim 1, wherein the guide parts are guide protrusions formed at edges of an upper portion of the housing, and the LC lens module is locked in the guide protrusions to be coupled to the housing, such that the center of the lens and the center of the LC lens are positioned on the same axis.

3. The camera module as set forth in claim 1, wherein the LC lens module includes:
the LC lens of which arrangement of a liquid crystal layer is adjusted by application of voltage;
an LC lens module body having the LC lens supported thereby and coupled thereto and fixed to the housing; and
a contact pin part electrically connected to the printed circuit board.

4. The camera module as set forth in claim 3, wherein the LC lens module further includes conductive bonding parts electrically connecting the LC lens to the LC lens module body.

5. The camera module as set forth in claim 3, wherein the LC lens module body is provided with a flexible connection part having changeable connection direction so that the LC lens is positioned over the housing so as to correspond to the lens and the contact pin part is positioned on a side portion of the housing so as to contact the printed circuit board.

6. The camera module as set forth in claim 1, wherein the guide parts are guide protrusions formed at edges of an upper portion of the housing, wherein the LC lens module includes the LC lens of which arrangement of a liquid crystal layer is adjusted by application of voltage, an LC lens module body having the LC lens supported thereby and coupled thereto and provided with fixing grooves corresponding to the guide protrusions of the housing, and a contact pin part formed in the module body so as to be electrically connected to the printed circuit board, the fixing grooves of the LC lens module being inserted into the guide protrusions of the housing to fix the LC lens module to the housing.

7. The camera module as set forth in claim 6, wherein the LC lens module further includes conductive bonding parts electrically connecting the LC lens to the LC lens module body.

8. The camera module as set forth in claim 6, wherein the LC lens module body is provided with a flexible connection part having changeable connection direction so that the LC lens is positioned over the housing so as to correspond to the lens and the contact pin part is positioned on a side portion of the housing so as to contact the printed circuit board.
